(19) United States
(12) Patent Application Publication
(10) Pub. No.: US 2025/0208264 A1
(43) Pub. Date: Jun. 26, 2025

(54) RANGING WITH INTEGRATED OPTICAL PARAMETRIC OSCILLATORS

(71) Applicant: California Institute of Technology, Pasadena, CA (US)

(72) Inventors: Alireza Marandi, Pasadena, CA (US); Selina Zhou, Pasadena, CA (US); Benjamin K. Gutierrez, Redondo Beach, CA (US); Robert M. Gray, Pasadena, CA (US)

(73) Assignee: California Institute of Technology, Pasadena, CA (US)

(21) Appl. No.: 18/990,696

(22) Filed: Dec. 20, 2024

Related U.S. Application Data
(60) Provisional application No. 63/612,749, filed on Dec. 20, 2023.

(51) Int. Cl. G01S 7/481; G01S 7/484; G01S 7/4861; G01S 7/4865; G01S 7/4911; G01S 17/10; G01S 17/34; G02B 6/00; G02B 6/12

(52) U.S. Cl. CPC G01S 7/4817; G01S 7/484; G01S 7/4861; G01S 7/4865; G01S 7/4911; G01S 17/10; G01S 17/34; G02B 6/12004; G02B 6/12009; G02B 2006/0098; G02B 2006/12107; G02B 2006/12164

(57) ABSTRACT

The present invention uses tunable or broadband integrated OPO with active or passive beam steering devices for high-speed ranging on a compact, low-cost platform. Examples of beam steering devices include grating couplers, optical phased arrays, arrayed waveguide delay lines, nanophotonic antennas, metasurfaces, etc. The beam steering device can be inside or outside of the OPO structure. Under broadband operation, the angular information is encoded in the spectral domain and vice versa, and the detector may have multiple spectral filters corresponding to different angles or a single tunable filter. The tunable filter can be electro-optic (EO) based or piezoelectric (PZT)-based. This invention can be realized across multiple material platforms with application specific parameters to optimize performance, such as bandwidth, tuning range, tuning speed, spatial/temporal resolution, polarization, field of view (FOV), etc. Scanning can be done in 1D and 2D. Multiple OPOs can be fabricated on chip with multiple beam steering devices.

### CROSS REFERENCE TO RELATED APPLICATIONS

This application claims the benefit under 35 U.S.C. Section 119(e) of U.S. Provisional Application No. 63/612,749, filed Dec. 20, 2023, by Alireza Marandi, Selina Zhou, Benjamin Gutierrez, and Robert M. Gray, entitled “INTEGRATED RANGING WITH OPTICAL PARAMETRIC OSCILLATORS,” (CIT-9114-P), which application is incorporated by reference herein.

### BACKGROUND OF THE INVENTION

### 1. Field of the Invention

This invention relates to advances in Light Detection and Ranging (LiDAR) technology, more specifically to the use of an integrated optical parametric oscillator (OPO) with on-chip or off-chip beam steering devices for ranging.

### 2. Description of the Related Art

(This application references a number of different references as indicated throughout the specification by one or more reference numbers in brackets, e.g., [x]. A list of these different references ordered according to these reference numbers can be found below in the section entitled “References.” Each of these is incorporated by reference herein.)

Light Detection and Ranging (LiDAR) is currently one of the most crucial sensor technologies in both research and industry, with a wide range of applications such as autonomous vehicles, artificially intelligent robots, precision agriculture, and atmospheric measurements [1]. Compared to radio detection and ranging (radar) technologies, LiDAR often offers higher resolutions and better accuracies for mapping 3D objects and their velocities, hence driving research efforts in both hardware developments as well as novel detection mechanisms.

Numerous different laser sources and beam steering mechanisms have been demonstrated for LiDAR, including pulsed operations in the traditional time-of-flight (TOF) measurements as well as continuous-wave (CW) operations for amplitude-modulated continuous-wave (AMCW) or frequency-modulated continuous-wave (FMCW) measurements. On the detection side, while electro-optic sampling has demonstrated sub-nanometer resolutions and few nanoseconds acquisition time, the combination of mechanical, optical, and electronics hardware in the sensor architecture can increase both system control and computation complexity [2]. As an example, the current industry standard in autonomous driving LiDAR requires a measurement range of at least 150 m, ability to distinguish objects of 10 cm in size, 350 degrees field-of-view (FOV), real time operation, and ability to function in poor weather conditions. In order to simultaneously satisfy these requirements, macro-mechanical scanning is typically employed, where multiple high quality laser sources are placed on a rotating structure. Apart from having bulky components in the optics, mechanical components often limit the frame rate to <50 Hz, in addition to suffering from system durability. As a result, there have been numerous efforts to miniaturize these scanning devices, such as using micro-scanners integrated with actuators on micro-electromechanical systems (MEMS) platforms [3]. Although MEMS devices have significantly reduced footprints, they often suffer from limited FOV as well as being prone to reduced SNR from mechanical vibrations [4].

More recently, metasurface-based LiDAR systems have been introduced, eliminating the problem of mechanical scanning being vulnerable to shocks and vibrations. For example, optical phased arrays (OPA) based on waveguide arrays with tunable phase delays no longer require any physical scanning of lenses or optical components [5]. Active beam steering is achieved through metasurface-based on transparent conductive oxide thin films such as indium tin oxide, and FOVs up to 80 degrees have been demonstrated [6]. However, metasurface-based LiDAR devices typically require unidirectional, coherent plane wave sources. Subsequently, hybrid integrations with high quality, wavelength-tunable laser sources create the problem of loss when coupling into chips. While there have been demonstrations of integration with LEDs and VCSELs, such as in flash LiDAR, these systems often suffer from short ranging distances and limited FOV ranging from 0 to 15 degrees [7]. Hence, there is still demand for a compact, monolithically integrated laser source and beam steering system with a small footprint and low cost. The present invention satisfies this need.

### SUMMARY OF THE INVENTION

The present invention uses tunable or broadband integrated parametric oscillators (OPOs) with active or passive beam steering devices for high-speed ranging on a compact, low-cost platform. Examples of beam steering devices include grating couplers, optical phased arrays, arrayed waveguide delay lines, nanophotonic antennas, metasurfaces, etc. The beam steering device can be inside or outside of the OPO structure.

Under broadband operation, the angular information is encoded in the spectral domain and vice versa, and the detector may have multiple spectral filters corresponding to different angles or a single tunable filter. The tunable filter can be EO based or PZT-based. This invention can be realized across multiple material platforms with application specific parameters to optimize performance, such as bandwidth, tuning range, tuning speed, spatial/temporal resolution, polarization, field of view (FOV), etc.

Multiple OPOs can be fabricated on the same chip along with multiple beam steering devices, to extend the wavelength tuning range and subsequent FOV in 1 dimension (1D) and two dimension (2D) scanning.

Illustrative embodiments include, but are not limited to, the following:

1. A device comprising:
one or more chips or photonic integrated circuits comprising at least one optical parametric oscillator (OPO) coupled to a beam steering device, the OPO operable to generate electromagnetic radiation comprising at least one of a signal or an idler in response to a pump, the beam steering device configured to provide emission away from the chips or photonic integrated circuits in response to the at least one wavelength of the electromagnetic radiation selected so the steering angle of the emission of the electromagnetic radiation can span a range larger than 5 degrees with respect to a surface normal of the beam steering device.

2. The device of claim 1, wherein the OPO is a wavelength-tunable OPO in which the wavelength of the signal and or idler can be tuned to provide beam steering of the electromagnetic radiation.

3. The device of clause 2, wherein tuning of the wavelength is achieved using an actuator coupled to the OPO, the actuator comprising an electro-optic modulator, a thermo-optic modulator, a heater, a piezo-electric device, or a vernier tuning device in the form of coupled resonators further coupled to the OPO.

4. The device of clause 1, further comprising an input for wavelength injection locking the OPO or wherein the OPO comprises a periodically poled nonlinear medium tuned for a desired wavelength range comprising the wavelength.

5. The device of clause 1, further comprising an input coupler to the OPO and a laser operable for inputting input electromagnetic radiation comprising at least one of an input signal, an input idler, or the pump, wherein tuning the wavelength of the inputted light can tune theat least one wavelength of the signal or the idler generated by the OPO.

6. The device of clause 1, comprising a plurality of the OPOs coupled in a cascaded or parallel configuration to output the electromagnetic radiation in a chain of wavelength conversions that extends a wavelength tuning range of the electromagnetic radiation coupled to the beam steering device.

7. The device of clause 6, wherein the OPOs each comprise at least one of:
a nonlinear medium comprising at least one of a different poling period or a configuration for outputting the electromagnetic radiation with a different center frequency,
or individual or multiplexed inputs/outputs.

8. The device of clause 1, wherein the at least one steering device comprises at least one of a grating coupler, a nanophotonic antenna, an optical phased array, an arrayed delay line, or a metasurface.

9. The device of clause 1, wherein the OPO comprises a resonator and one of the chips or photonic integrated circuits comprises the OPO and the beam steering device, and wherein the beam steering device is placed inside or outside the resonator.

10. The device of clause 1, comprising a plurality of the beam steering devices configured for multibeam steering or steering of the electromagnetic radiation in different directions to enable two dimensional (2D) scanning of the beam or beams.

11. The device of clause 1, wherein the OPO comprises a broadband OPO which has multimode operation for the signal and idler, for instance in the form of a frequency comb OPO or a short-pulse OPO, wherein the beam steering device provides different steering angles for different spectral components of the electromagnetic radiation from the OPO, hence encoding the angular distribution to the spectral distribution of the electromagnetic radiation.

12. The device of clause 1, further comprising:
a receiving unit on the same one of the chips as the OPO or on a separate one of the chips to realize a ranging device wherein the receiving unit comprises one or more spectral filters or a wavelength division demultiplexer configured to route different wavelength components of a beam comprising a received portion of the electromagnetic radiation, corresponding to different angles of incidence of the beam, to different outputs, or
an EO-based or PZT-based tunable filter, wherein the tunable filter can selectively route different angles of incidence of the beam to one or multiple outputs.

13. A device comprising the device of clause 1 comprising one or more of the OPOs and one or more of the beam steering devices configured for outputting a beam of the electromagnetic radiation with a desired scanning range and speed.

14. The device of clause 1 further comprising a control circuit controlling tuning of the at least one wavelength of the electromagnetic radiation to implement beam steering of the emission at sub-Hz to MHz speed over the scanning angle of the emission.

15. The device of clause 14, wherein the control circuit is further configured to provide frequency-modulated continuous wave (FMCW) modulation of the electromagnetic radiation as well as beam steering of the electromagnetic radiation.

16. The device of clause 14, wherein the control circuit is further configured for outputting the electromagnetic radiation comprising pulses ranging from nanosecond to femtosecond pulse lengths useful for time of flight (TOF) measurements in addition to the beam steering of the beam.

17. The device of clause 1, further comprising an input coupler configured for inputting a continuous-wave or pulsed pump to the OPO.

18. The device of clause 1, wherein the OPO is configured to output the electromagnetic radiation comprising a frequency comb or a pulse having a duration in a range of 1 fs to 1 ns.

19. A transceiver comprising the device of clause 1, further comprising:
an input coupler for receiving the beam after interaction of the emission with a target; and
a detector for detecting the electromagnetic radiation received at the input coupler.

20. A LIDAR or remote sensing system comprising the device of clause 1.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1. Example of proposed laser generation and beam steering mechanism. A device-integrated laser source is coupled to an optical parametric oscillator (OPO). The frequency output of the OPO can be tuned, such as by using electro-optic modulators. The OPO output is shown coupled to a free-space light beam using a grating coupler, engineered so that the bandwidth of the OPO output corresponds to some field of view depending on the design of the grating structures. Other types of passive or active beam steering devices, such as optical phased arrays and nanophotonic antennas, can replace the grating coupler. Note that the beam steering device does not necessarily need to be on the same chip as the OPO.

FIG. 2. System flow chart of a proposed LiDAR scheme. The availability of different operation schemes enables the platform, bandwidth, and tuning range of the OPO LiDAR system to be tailored for needs of specific applications.

FIG. 3. Beam steering inside an OPO. Here the device again consists of an integrated laser source coupled to an on-chip tunable OPO. In a non-degenerate doubly-resonant OPO, the signal and idler resonating in the cavity are of different wavelengths. If the grating coupler is designed to partially outcouple both the idler beam and the signal beam, due to their difference in wavelengths, they would also be out-coupled in different angles. This effectively achieves dual beam steering, which results in larger FOV compared to the case of single beam steering. Coarse tuning and fine tuning of the signal and idler wavelengths can be achieved through at least one of pump tuning, EOMs, and thermal tuning of the PPLN region.

FIG. 4. Broadband operation of the OPO. The OPO is used in a pulsed configuration, generating an output which is broadband, potentially spanning multiple octaves in bandwidth. A grating sends the broadband OPO output towards the object, with different frequencies corresponding to different output angles. A broadband, angularly insensitive receiver collects the reflected light and interferes it with a coupled portion of the OPO output as a local oscillator before feeding it into a frequency-selective measurement scheme. Here, a wavelength-division multiplexer and detector are shown.

FIG. 5a-5d. Beam steering in 1D (FIGS. 5a and 5b) and 2D (FIGS. 5c and 5d).

FIG. 6. Flowchart illustrating a method of making a device.

FIG. 7. Schematic of a LIDAR or Remote sensing system.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

The present invention consists of an on-chip LiDAR system, where an integrated OPO is coupled to an on-chip beam steering device, including but not limited to grating couplers, optical phased arrays, arrayed waveguide delay lines, nanophotonic antennas, and metasurfaces. The availability of different operation schemes enables the platform, bandwidth, and tuning range of the OPO LiDAR system to be tailored for needs of specific applications. We have previously demonstrated on-chip tunable OPO in near-IR wavelength regions, with few nanometers' bandwidth [11]. We have also shown an integrated OPO acting as a synchronously-pumped multi-octave frequency comb source, which is suitable for broadband operations [12]. In the following paragraphs, we first describe an example using a passive beam steering device with a tunable OPO to achieve a FOV of 60 degrees. We then discuss the types of tuning that can be implemented with our integrated OPOs in order to meet the needs of various passive beam steering devices, specifically the achievable tuning range and tuning speeds using different methods. Finally, we introduce an alternative to beam steering with wavelength tuning, where the OPO operates as a broadband source with angular information encoded in the different wavelengths.

### 1. Passive Beam Steering

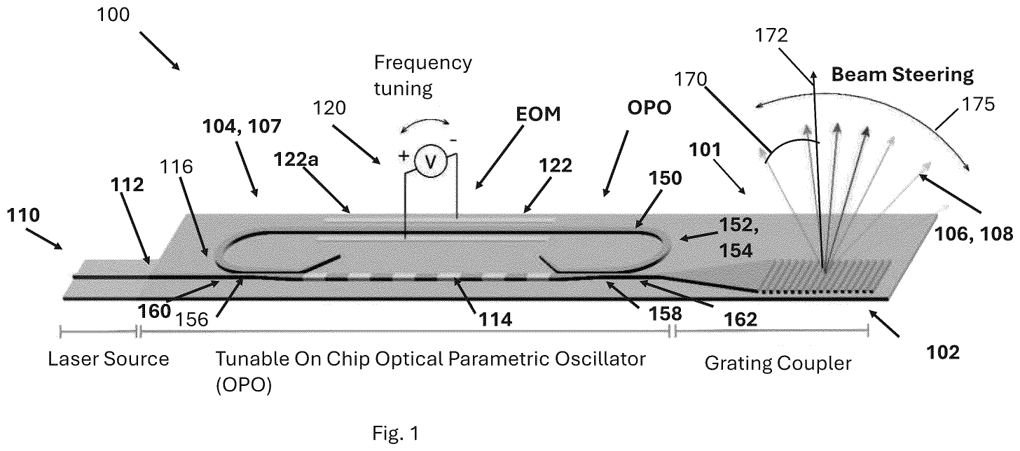

As an example of an on-chip passive beam steering device, consider a simple grating structure 102 fabricated on thin film lithium niobate (TFLN) platform 104, as shown in FIG. 1. The embodiment of FIG. 1, a device 100 (that may be useful in a transmitter or transceiver) comprises one or more chips 101 or photonic integrated circuits 107 comprising at least one wavelength-tunable optical parametric oscillator (OPO) coupled to at least one beam steering device 102, wherein the at least one beam steering device steers a beam 106, comprising electromagnetic radiation 108 received from the OPO, away from the chips or photonic integrated circuits.

FIG. 1 further illustrates the chip further comprises at least one actuator 120 with electrodes 122 coupled to the OPO, wherein the actuator is operable to tune a wavelength of the electromagnetic radiation outputted from the OPO. FIG. 1 further illustrates the OPO comprises a resonator 152 comprising a waveguide 150 comprising a nonlinear medium 114, an input coupler 156 coupled to the resonator, e.g., for inputting the pump and an output coupler 158, e.g., for outputting the idler or the signal generated in response to the pump using a nonlinear process. In an embodiment, the resonator comprises a ring resonator 154, the input coupler can comprise e.g., an input waveguide 160 coupled to the resonator via a first gap and the output coupler 158 can comprise e.g., an output waveguide 162 coupled to the resonator via a second gap.

FIG. 1 further illustrates the beam steering device 102 can be configured to provide emission away from the chips or photonic integrated circuits in response to the at least one wavelength of the electromagnetic radiation selected so the steering angle 170 of the emission or beam 106 of the electromagnetic radiation can span a range, e.g., larger than 5 degrees with respect to a surface normal 172 of the beam steering device.

Note that the beam steering device 102 steering one or more beams 106 can but does not need to be on the same chip 101 as the OPO. It can also be off-chip, on a separate nanophotonic platform (such as a Silicon phased-array chip [14]) or a bulk-optics devices and coupled to the OPO chip via edge or surface coupling. For this example, we choose a center wavelength of electromagnetic radiation 108 around 2 μm, which is generally considered eye safe. Based on Bragg theory, the outcoupling angle θ and wavelength λ relation of a grating structure with an even pitch (Λ) is given by:

$$Λ = \frac{λ}{{n}_{eff} - sin ( {θ}_{air} )}$$

If we restrict the free-space outcoupled beam 108 to the 1^{st} diffraction order, then for a 700 nm TFLN on silica, the effective index n_{eff} is approximately 2.05 based on FDTD simulations. Substituting wavelength into the Bragg condition above, we can find a theoretically optimal pitch value for the center wavelength. Assuming a coupling angle θₐᵢᵣ of 0 degrees (normal to chip surface), the corresponding pitch is 952 nm. Fixing the pitch value, we can find a relation between wavelength and outcoupling angle. In order to achieve an FOV of 60 degrees, the corresponding wavelength tuning range is from approximately 1800 nm to 2600 nm, which can be achieved through a singly resonant OPO pumped at 1 μm with temperature tuning. Further simulations and far field projection analysis are required to fully characterize the beam quality and divergence angles, but from the above back-of-envelope calculations, the OPO LiDAR can potentially achieve FOVs wider than state-of-the-art metasurface-based LiDAR systems.

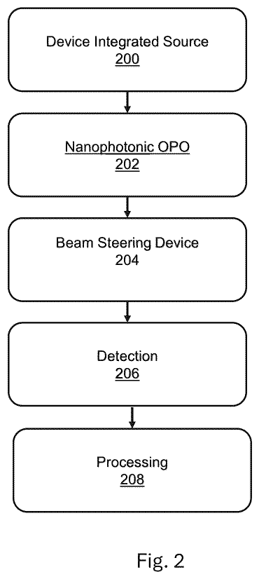

FIG. 2 illustrates a method of fabricating a device, or a method of beam steering, comprising outputting electromagnetic from a device integrated source 200 (or coupling the source to a nanophotonic OPO 202, outputting electromagnetic radiation from (or coupling the OPO to) a beam steering device 204, outputting/steering a beam from the beam steering device, coupling a detector/detection system 206, or detecting the beam (after interaction with a target) on a detector/detection system 206; and coupling a processor for (e.g., processing 208) a signal outputted from the detector in response to the detection.

The device integrated source 200 may comprise, for example, commercially available laser diode, distributed feedback laser (DFB), gain material, mode locked laser, or vertical cavity surface emitting laser (VCSEL).

The nanophotonic OPO 202 may comprise wavelength tunable OPO for FMCW, or broadband pulsed OPO, wherein one or more OPOs are integrated on the chip.

The beam steering device 204 and detection system 206 may comprise one or more grating couplers, one or more phased arrays, one or more delay lines, one or more nanophotonic antennas, or one or more metasurfaces.

The detection 204 may be on or off chip and the processing 208 may be on or off chip with the possibility for all optical processing.

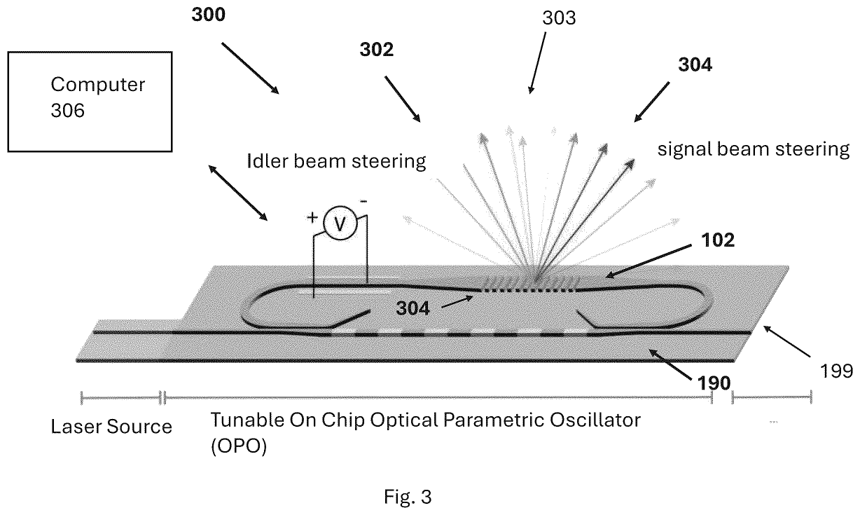

FIG. 3 shows how through careful engineering of the beam steering device, it is also possible to realize multiple-beams 302, 304 steering concurrently, such as by using two different grating periods on one device (or even one grating 102) or using a more traditional optical phased arrays [15-16]. Similar effects can be achieved by placing a grating structure inside the resonant cavity of a doubly- (or triply-) resonant OPO, so different wavelengths can simultaneously be steered at different angles.

In addition to grating structures with separations comparable to wavelength, larger nanophotonic antennas have also been demonstrated for beam steering, with significant improvements on FOV (by creating aliasing-free beams) and beam divergence angle. A combination of grating couplers and/or antennas for beam steering with a tunable OPO can realize large FOV, small beam divergence angle, and monolithic source integration at the same time.

Beam scanning can also be achieved with optical phased arrays (OPAs), which can be coupled to gratings and antennas for surface-emitting beam steering, or simply edge-emitting with tapered waveguides. The FOV and beam quality depends on metrics such as number of channels in the phase modulator array, as well as the size of the grating emitter area. A major limitation in existing OPA demonstrations is the high coupling loss when the tunable laser source is off chip. Due to tight optical confinement of lithium niobate on insulator (LNOI) waveguides, low-loss TE mode propagation can be achieved. LNOI tunable OPOs exploit both low-loss propagation and enhanced nonlinearity in nanophotonic waveguide structures, on top of lithium niobate being one of the best electro-optic Pockels material, making it suitable for refractive index modulation in addition to temperature tuning.

Hence, combination of tunable laser source with grating structures and/or antennas and optical phased arrays can enable low-loss, high speed LiDAR on a compact platform. For instance, using an array of antennas over a larger area on the chip can increase the numerical aperture and directionality of beam steering compared to that of a grating coupler. Additionally, having both grating structures and OPAs, or multiple (>1) grating structures patterned in different orientations, can enable 2D scanning in both the x and y directions (where x is the crystal c-axis for a x-cut TFLN platform), making the device suitable for various applications. Combined with the possibility of multi-beam steering at multiple wavelengths such as depicted in FIG. 3, the use of an integrated OPO as the tunable source for an on-chip beam steering device can enable several novel schemes of LiDAR beam steering.

### 2. Wavelength Tuning

Here we discuss various tuning mechanisms that can be employed in engineering the tunable OPOs for beam steering. In the previous section, we showed that achieving a FOV of 60 degrees using a grating coupler require a roughly 800 nm tuning range around a 2 μm center wavelength. While the OPO platform material itself is not limited to TFLN, here we continue using LNOI as an example due to lithium niobate's thermo-optic, electro-optic, and piezoelectric effects.

Furthermore, LNOI tunable OPOs exploit both low-loss propagation and enhanced nonlinearity in nanophotonic waveguide structures, making it especially suitable for achieving coarse and/or fine-tuning of wavelengths on an integrated platform. Wavelength tuning is essential not only in achieving the target FOV via passive beam steering but is also the basis for many LiDAR operations such as FMCW, which requires fine control over the wavelength tuning at high speed. In both coarse and fine beam steering, tuning along a passive waveguide imparts a phase shift on the passing radiation. A summary of different tuning mechanisms and their corresponding tuning range and typical tuning speeds are presented in Table 1.

TABLE 1
Wavelength tuning mechanisms and their corresponding tuning
range and typical tuning speeds. Electro-optic (EO) tuning
is suitable for fine-tuning, meeting speed requirements for
LiDAR techniques such as FMCW. Thermal tuning of the PPLN
can achieve the largest tuning range albeit slower tuning
speeds, but is still sufficient for coarse wavelength tuning

| | | |
|---|---|---|
| Mechanism | Tuning range | Tuning Speed |

| | | | | |
|---|---|---|---|---|
| Resonator EO Tuning | <1 | nm | <10 | GHz |
| Vernier EO Tuning | <50 | nm | <1 | GHz |
| Injection Locked Tuning | <100 | nm | <1 | GHz |
| Pump Tuning | <500 | nm | <1 | GHz |
| PPLN Thermal Tuning | ~1000 | nm | <10 | Hz |

We first consider fine tunings. When tuning is applied within a resonator, the frequency modes that resonate in that cavity shifts, in this case resulting in a shift in the OPO output, which can be as large as the free spectral range (FSR) of the cavity. Even in integrated devices with large FSRs on the order of nanometers or less, this tuning range is relatively small when compared to our target tuning range of hundreds of nanometers, hence is ideal for raging techniques such as FMCW. One option to increase the tuning range of such resonators is to utilize the Vernier effect in which more than one resonator with similar FSRs are coupled to each other. The overlap of frequency modes between the resonators creates an effective FSR on the order of tens of nanometers, which is larger than the individual FSRs of either resonator. In such configuration, by tuning each of these resonators, a single frequency mode may be tuned across an extended range, resulting in a medium-range wavelength tuning.

To achieve a coarse tuning range, there are several different options, namely through directly tuning the pump wavelength, injection locking the signal wavelength, tuning the periodically-poled lithium niobate (PPLN) region, or thermal tuning. First, tuning the pump wavelength of the OPO results in an extended tuning range in the signal and idler wavelengths. For example, if we tune the pump wavelength by 30 nm around 1045 nm, the resulting wavelength tuning in the signal and idler wavelengths are 400 nm and 500 nm, respectively. Note that a medium-range pump tuning results in a much larger tuning range of the output wavelengths. The pump wavelength may be tuned either off-chip using a tunable laser 110, or on-chip using an extended cavity laser diode configuration employing an on-chip Vernier reflector. The Vernier reflector may be EO tuned, resulting in relatively high-speed pump tuning, which translates to large-wavelength range tuning.

Alternatively, we can also keep the pump wavelength fixed and inject an additional signal wavelength into the OPO to injection lock the idler wavelength. In general, the change in idler wavelength λi with respect to the change in signal wavelength λs in an OPO is given by the following relation:

$$\frac{d {λ}_{i}}{d {λ}_{s}} = - {[ \frac{{λ}_{p}}{{λ}_{s} - {λ}_{p}} ]}^{2}$$

As an example, with a pump wavelength λp of 1045 nanometers (nm), tuning the signal wavelength by 30 nm (from 1755 nm to 1785 nm) would result in tuning of the idler wavelength by 62 nm (from 2583 nm to 2523 nm).

Another option for coarse tuning is to directly tune the PPLN section of the OPO to adjust the parametric gain center frequency. Much like tuning of the pump wavelength, tuning the PPLN section can result in hundreds of nanometers of wavelength tuning in the signal/idler. Although a large index shift is required to achieve such tuning range, when combined with pump tuning, a tuning range exceeding 1 μm is achievable. Finally, it is well known that thermal tuning enacts a large index shift in LN, albeit slow when compared to either electro-optic or piezoelectric tuning. Therefore, thermal tuning is better suited for coarse tuning, such as of the PPLN section, and can be achieved at speeds on the order of Hertz.

Finally, to achieve high-speed fine tuning, electro-optic modulators (EOMs) may be used to tune the OPO cavity. The cavity may further be coupled to an additional resonator to extend this tuning via the Vernier effect described earlier. Here, tuning both the main cavity and the additional resonator can result in medium-range wavelength tuning. Note that since the coordination of tuning both cavities is required, the tuning speed may be slightly slower than tuning a single cavity.

Summarizing this section, in general, any combination of the aforementioned techniques may be used for on-chip wavelength-tuning to meet the requirements of different ranging techniques. On top of individual device tuning, more than one OPO may be implemented on a single chip, each having a different poling period to extend the tuning range of the entire chip. A single pump may be routed to all OPOs on the chip using an electro-optic switch, and the outputs of the OPOs may be used individually or also routed to a single waveguide to produce a combined source. Furthermore, each OPO may be of any type, namely triply-resonant, doubly-resonant, singly-resonant, pump-enhanced, or intracavity, depending on the needs of different applications. It is also possible to cascade multiple OPOs in a chain, to further extend the wavelength range and tuning capability.

### 3. Broadband OPOs

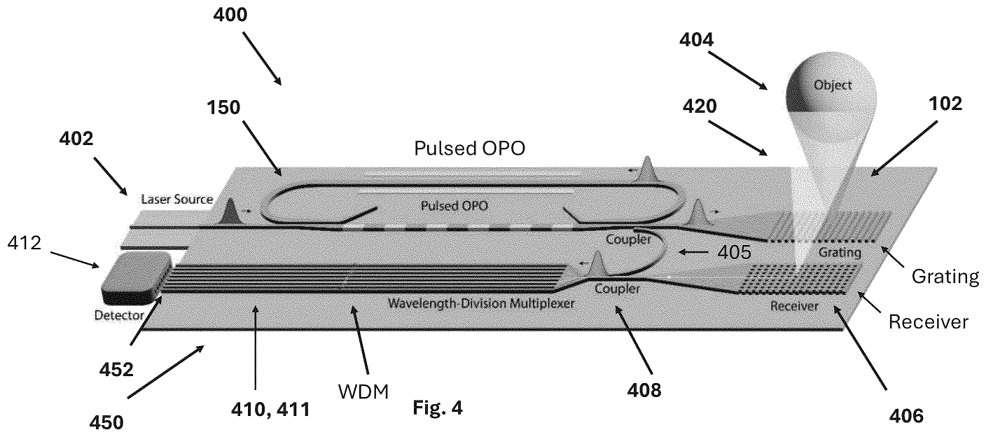

The OPO LiDaR system may also be used in a pulsed (synchronously-pumped) configuration (see FIG. 4). Here, a pulsed laser source 402 sends light into the OPO, and the OPO is used for down-conversion and spectral broadening, with the output potentially spanning multiple octaves in wavelength. A coupler 405 sends part of the OPO output to the detection channel for use as a local oscillator, while the remaining light is sent to a grating (or other types of beam steering devices 102) for outcoupling the light towards the object 404. As with the CW OPO LiDaR system, different frequencies are diffracted into different angles.

The reflected light from the object is then captured and sent to the detection system. In FIG. 4, a broadband collector 406 is illustrated, which may consist of an inverse-designed grating structure or metasurfaces placed on the waveguide, among others. It is designed to have a wide capture angle for all frequencies. The collected light is then interfered with the local oscillator in coupler 408 and passed into a wavelength-division multiplexer (WDM). Finally, the different channels 410 of the WDM are sent to a detector 412. In this case, each channel represents a different output angle from the grating, and the bandwidth of the channel will correlate to the angular resolution.

Several modifications of this system may also be considered. Firstly, a pulsed pump is not required, but a CW laser may instead be used. In the case of CW pumping, pulses may be generated through soliton formation or a form of active or passive mode-locking, with the OPO placed inside the mode-locked laser cavity. In addition, a multi-channel WDM is not required for the detection. Instead, another spectrally selective measurement may be used; examples include the use of a tunable frequency filter with a detector or a dual-comb-based approach. Finally, additional actuators may be placed on the chip for modulation of the light as may be necessary depending on the LiDaR configuration used (e.g., multi-channel FMCW or AMCW).

### 4.1D and 2D Steering

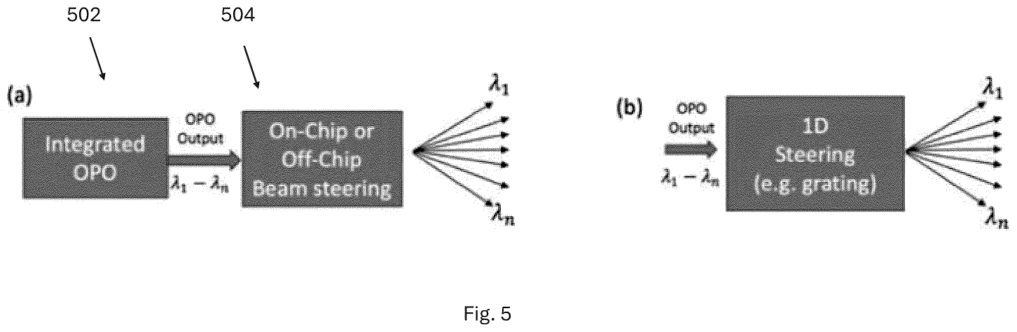

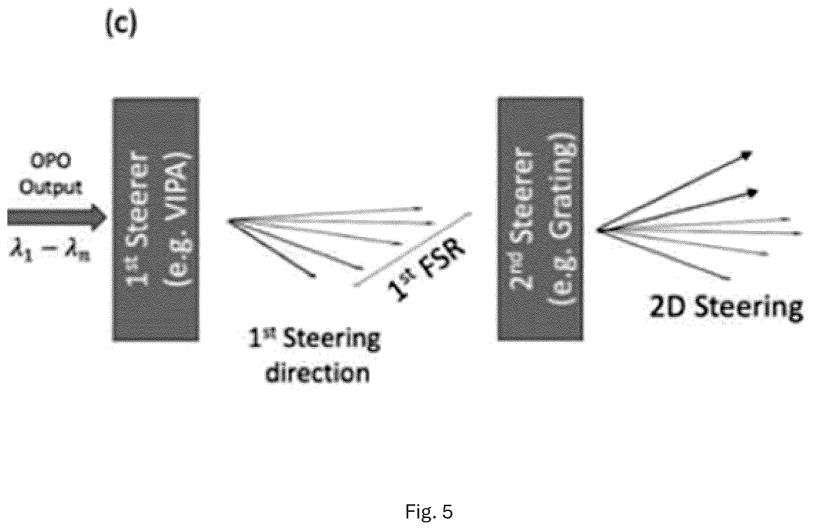

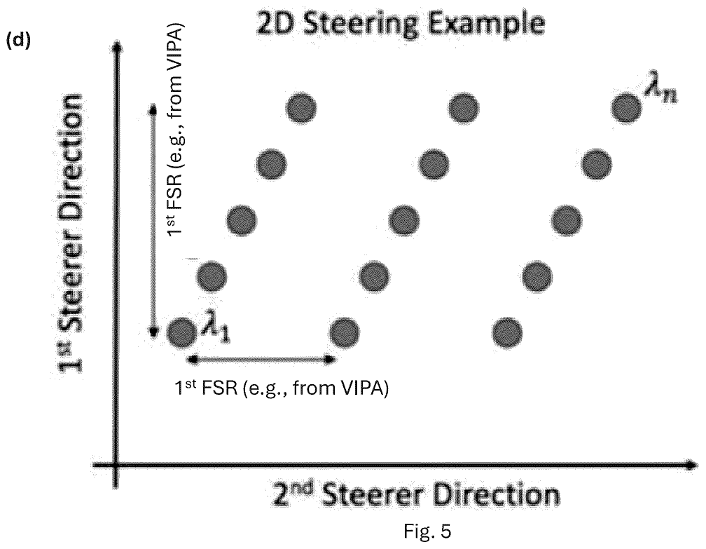

The idea of steering the OPO output as a beam based on its wavelength can be realized in 1D and 2D. This is illustrated in FIG. 5. A tunable or broadband OPO 502 covering a wavelength range from λₗ to λ_{N} can be coupled to a beam steerer 504, either on the chip or outside the chip, for instance a grating as shown in FIG. 5 a,b. The 1D steering can be done with a single steerer (b), however, a combination of two steerer can be used to achieve a 2D scan. This is illustrated in (c) and (d). In this case, for instance, the 1^{st} steerer can be a virtually imaged phased array (VIPA) [17], the free-spectral range (FSR) of which defines the steering coverage of the 1^{st} steerer, while the second steerer can be a grating, which can steer the beam after the first steerer. The combination results in a field of view for which a single direction in the 2D space corresponds to a single wavelength. This configuration can either be implemented on the same chip of the OPO, partially on-chip, or completely off chip.

### Process Steps

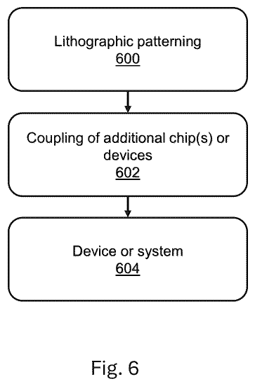

FIG. 6 is a flowchart illustrating a method of making a device according to one or more embodiments.

Block 600 represents using lithographic patterning of a substrate (199 in FIG. 1) combined with etching, periodically poling, and depositing of metals to form a photonic integrated circuit comprising at least one wavelength-tunable optical parametric oscillator (OPO) coupled to at least one beam steering device, wherein the at least one beam steering device steers a beam, comprising electromagnetic radiation received from the OPO, away from the chips or photonic integrated circuits.

In one or more embodiments, the nonlinear waveguides in the OPO comprises nonlinear materials comprising a second order nonlinear susceptibility and use second order nonlinear processes to convert a pump pulse/electromagnetic radiation into a signal and/or idler pulse/electromagnetic radiation outputted to the output coupler.

In one or more examples, the circuit is formed on a (e.g., thin) film with (e.g., strong) second order nonlinearity, such as lithium niobate or lithium tantalate, on substrates including silicon dioxide on a silicon, silicon dioxide on bulk lithium niobate, quartz and sapphire, and wherein the nonlinear waveguide comprises periodic poling of the lithium niobate thin film.

In one or more examples, the substrate 104 comprises lithium niobate on silicon dioxide, and the waveguides are patterned (e.g., etched) in the lithium niobate (monolithic integration of the waveguides). Other components such as a pump laser, injection locking input, or auxiliary resonators or beam steering device(s) 102 (grating), collector/receiver 406, or spectral filters 411 or WDM can be patterned (e.g., etched) in the same substrate or on a different material substrate bonded to the substrate containing the OPO.

In some embodiments, the nonlinear materials in the waveguides are dispersion engineered to control appropriate group velocity dispersion (GVD) of, and group velocity mismatch (GVM) between, pump and signal/idler pulses so as to control temporal overlap/walk off of the pump and signal/idler pulses or other functionalities useful for beam steering. The dispersion engineering (GVD and GVM) is controlled by tailoring the size of the cross sectional area and/or top width of the waveguides.

In one or more embodiments, a top width of the waveguide is less than 5 microns (e.g., but not limited to 3-4 microns for some longer wavelength devices achieving some dispersion parameters) and a height of waveguide is less than 1 micron (e.g., 600-800 nm)

Quasi-phase matching (e.g., using periodic poling) of the nonlinear waveguides can be selected for a variety of nonlinear processes. The poling enables phase matching for some frequency components but not others, and the target frequency components can be engineered for example via chirped poling.

The waveguides can be phase matched and dispersion engineered to output electromagnetic radiation having a range of wavelengths (e.g., 1-20 microns) or frequency combs, or broadband ranges sufficient to support output of pulses electromagnetic radiation e.g., in a range of ′1 fs-1 nanosecond.

With or without cladding layers, actuators (e.g., electro-optic modulator, an electric heater, a thermo-optical heater, or a piezoelectric transducer, e.g., to modulate phase or amplitude of waves or refractive index of the nonlinear material using electric field or temperature) can be fabricated by depositing metallization coupled to the waveguides formed in the chip.

Block 602 represents optionally coupling another chip (e.g., with the output coupler) or other devices such as an emitter (e.g., laser source) for pumping or injection locking the OPO. The coupling between the chips can be edge coupling, where waveguides are configured to couple light from one chip to another, or surface coupling, where the light is coupled from one chip to another through the surface of one chip for instance using evanescent coupling or grating couplers.

Examples of the emitter include, but are not limited to, a semiconductor emitter includes one, or a combination of, or a plurality of a Vertical cavity semiconductor laser (VCSEL), Vertical external cavity semiconductor lasers (VECSEL), edge-emitting Fabry-Perot laser, Edge-emitting distributed feedback laser (DFB), edge-emitting distributed Bragg lasers (DBR), edge-emitting gain chip, edge-emitting light emitting diodes, or optically pumped semiconductor gain element. Typical emitter materials include, but are not limited to semiconductors such as III-V semiconductors or semiconductors comprising biased p-n junctions comprising e.g., GaAs, AlGaAs, InP, GaN, AlGaN, InAlGaN, InGaN wherein electromagnetic radiation is emitted by recombination of holes and electrons injected into the device or by optical pumping. Typical emission wavelengths include, but are not limited to visible through infrared, e.g., 400 nm-10 microns, and typically communication wavelengths between 800 nm and 2 microns.

Block 604 represents the end result, a system or device useful as a transmitter and/or receiver of beam steered electromagnetic radiation. The device can be further coupled in a system, e.g., remote sensing or LIDAR system.

In one or more embodiments, tuning of the wavelength in the OPO causes steering by the beam steering device (grating) because different wavelengths are diffracted in different directions- so a beam steering angle of more than 5 degrees with respect to vertical would be possible due to tuning of the appropriate wavelength in combination with the grating spacing. Broadband pulses have a large wavelength spread and therefore give larger angles and spread of angles.

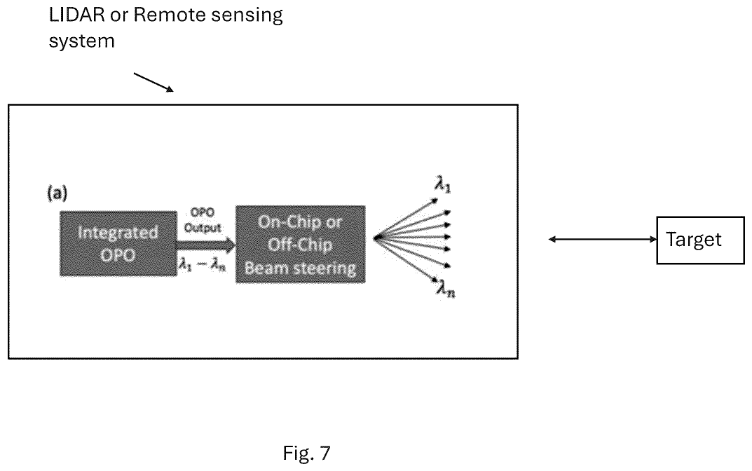

Illustrative embodiments include, but are not limited to, the following (referring with reference numbers, letters, words or symbols also to FIGS. 1-7).

1. A device 100 useful in a transmitter or transceiver, comprising:
one or more chips 101 or photonic integrated circuits 107 comprising at least one wavelength-tunable optical parametric oscillator (OPO) coupled or connected to at least one beam steering device 102, wherein the at least one output coupler steers a beam 106, comprising electromagnetic radiation 108 received from the OPO, away from the chips or photonic integrated circuits.

2. The device of clause 1, wherein the chip further comprises at least one actuator 120 coupled to the OPO, wherein the actuator is operable to tune a wavelength of the electromagnetic radiation outputted from the OPO.

3. The device of clause 1 or 2, wherein the actuator comprises an electro-optic modulator EOM, a thermo-optic modulator, a heater, a piezo-electric device, or a vernier tuning device.

4. The device of any of the clauses 1-3, further comprising an input 112, 156 for wavelength injection locking the OPO or wherein the OPO comprises a (e.g., periodically poled) nonlinear medium 114 tuned for a desired wavelength range of the electromagnetic radiation.

5. The device of any of the clauses 1-4, further comprising an input coupler 116, 156 to the OPO and a laser 110 operable for inputting at least one of a signal, idler, or pump that tunes a wavelength of the electromagnetic radiation when inputted to the input coupler.

6. The device of clauses 1-5, comprising a plurality of the OPOs coupled in a cascaded configuration to output the electromagnetic radiation in a chain of wavelength conversions that extends a wavelength tuning range of the electromagnetic radiation coupled to the output coupler.

7. The device of any of the clauses 1-6, wherein the OPOs each comprise at least one of:
a nonlinear medium 114 comprising at least one of a different poling period or a configuration for outputting the electromagnetic radiation with a different center frequency,
or individual or multiplexed inputs/outputs 190.

8. The device of any of the clauses 1-7, wherein the at least one beam steering device 102 comprises at least one of a grating coupler, nanophotonic antenna, an optical phased array, an arrayed delay lines, or a metasurface.

9. The device of any of the clauses 1-8, comprising one of the chips or photonic integrated circuits comprising the OPO and the output coupler and wherein the beam steering device is placed inside 304 or outside the OPO.

10. The device of any of the clauses 1-9, comprising a plurality of the beam steering devices 102 configured for multibeam steering 303 or steering of the electromagnetic radiation 108 in different directions to enable 2D scanning of the beam or beams.

11. The device of clauses 1-10, wherein the OPO comprises an ultra-broadband OPO wherein angular information of the directions of the steering of the beam 106 is encoded in a spectral domain of the electromagnetic radiation.

12. The device of any of the clauses 1-11, further comprising:
one or more spectral filters 411, WDM coupled to an input coupler or collector 406 (e.g, grating, antenna, other examples as for beam steering device 102) and a detector 412, the spectral filters configured to route different wavelength components of the beam, corresponding to different angles of incidence of the beam received on the input coupler, to different inputs to the detector, or
an electro optic-based or piezoelectric (PZT)-based tunable filter coupled to the input coupler and the detector, wherein the tunable filter routes the different angles of incidence to the different inputs on the detector.

13. The device of any of the clauses 1-12 comprising a ranging device comprising one or more of the OPOs and one or more of the beam steering devices 102 configured for outputting the beam 106 with a desired scanning range and speed.

14. The device of any of the clauses 1-13 further comprising a control circuit or computer 306 (e.g., processor, application specific integrated circuit, field programmable gate array or other integrated circuit) controlling tuning of wavelengths of the electromagnetic radiation 108 to implement a ranging application or time of flight application.

15. The device of clause 14, wherein the control circuit 306 is configured to tune the wavelengths to output the beam comprising frequency-modulated continuous wave (FMCW) electromagnetic radiation 108 at kHz to MHz wavelength tuning speeds,

16. The device of clause 14, wherein the control circuit 306 is configured to tune the wavelengths or control the OPO for outputting the electromagnetic radiation 108 comprising nanosecond or picosecond pulses useful for time of flight (TOF) operation of the device.

17. The device of any of the clauses 1-16 further comprising an input coupler 156 configured for inputting a continuous-wave or pulsed pump to the OPO.

18. The device of any of the clauses 1-17, wherein the OPO is configured to output the electromagnetic radiation 108 comprising a frequency comb or a pulse having a duration in a range of 1 femtosecond to 1 nanosecond.

19. A transceiver comprising the device 400 of any of the clauses 1-18, further comprising:
an input coupler or receiver or collector 406 for receiving the beam 420 after interaction of the beam 106 with a target 404, and
a detector 412 for detecting the electromagnetic radiation received at the input coupler.

20. A LIDAR or remote sensing system comprising the device of any of the clauses 1-19.

21. A method of sensing, comprising outputting/steering/transmitting electromagnetic radiation from a beam steering device coupled to an optical parametric oscillator (OPO), wherein the electromagnetic radiation is outputted from the OPO and is steered by the beam steering device to a target or object.

22. The method of clause 21, further comprising receiving the electromagnetic radiation after interaction with the target, on a receiver.

23. The method of any of the clauses using the device of any of the clauses 1-20.

24. A method of making a device comprising integrating on, or fabricating one or more chips 101 or photonic integrated circuits 107 comprising, at least one wavelength-tunable optical parametric oscillator (OPO) coupled to at least one output coupler 102, wherein the at least one output coupler steers a beam 106, comprising electromagnetic radiation 108 received from the OPO, away from the chips or photonic integrated circuits.

25. The device of any of the clauses 1-20 manufactured using the method of clause 24.

26. The device of any of the clauses 1-20, wherein the OPO comprises a waveguide 150 comprising a nonlinear medium having a second order nonlinear susceptibility configured for outputting the electromagnetic radiation using a nonlinear process, e.g., in response to a pump.

27. The device or method of any of the clauses 1-27, wherein the waveguide has a thickness of the order of a wavelength of the electromagnetic radiation and/or has a cross sectional area A that supports an electromagnetic mode which has more than 90% of its energy confined in the area A smaller than 5 microns by 5 microns, and/or wherein the waveguide thickness is less than 1 micron (e.g., in a range of 50-990 nm).

28. The device of any of the clauses 1-27, wherein the actuator comprises a pair of electrodes 122a (e.g. comprising metal) coupled to the waveguide 150 for tuning the wavelength via application of voltage V across the electrodes 122a, e.g. wherein the voltage applies a field modulating a refractive index or other property of the nonlinear medium.

29. A device comprising:
one or more chips or photonic integrated circuits comprising at least one optical parametric oscillator (OPO) in which the electromagnetic radiation from the OPO, which includes one or both of the signal and idler are coupled to at least one beam steering device, wherein the beam steering device provides emission away from the chips or photonic integrated circuits in response to the wavelength of the electromagnetic radiation wherein the steering angle of the electromagnetic radiation depends on its wavelength and the steering angle 170 is larger than 5 degrees with respect to the surface 172 of the beam steering device (or with respect to a surface plane 172 of the chip).

30. The device of any of the clauses, wherein the OPO comprises a resonator 152 comprising a waveguide 150 comprising a nonlinear medium, an input coupler 156 coupled to the resonator for inputting the pump and an output coupler 158 for outputting the idler or the signal.

31. The device of clause 30, wherein the resonator comprises a ring 154, the input coupler comprises an input waveguide 160 coupled to the resonator via a first gap and the output coupler 158 comprises an output waveguide 162 coupled to the resonator via a second gap.

32. The device of clause 30, wherein the resonator comprises a linear resonator and the input and output couplers comprise mirrors defining a cavity of the resonator.

33 The device of any of the clauses 1-32 coupled to a continuous wave (CW) laser, where the tuning comes from different wavelengths being diffracted in different directions; a spectrally resolved measurement may be used to determine the angle, or the control parameter (i.e., voltage) which sets the wavelength of operation of the OPO.

34. The device of any of the clauses 1-32, wherein the OPO comprises a broadband OPO illuminating all angles simultaneously and therefore requiring a spectrally resolved measurement on the readout to get positional information.

35. Other broadband sources (not just OPOs) can be coupled to the beam steering device. In other embodiments, a nonlinear medium, e.g., with second order nonlinear susceptibility, is configured as a frequency comb generator, or short pulse synthesizer, or mode locked laser and the electromagnetic radiation outputted from the integrated nonlinear medium (e.g., in a waveguide) can be coupled to the beam steering device.

36. A device 100, 300, 400 one or more chips 101 or photonic integrated circuits 107 comprising at least one optical parametric oscillator (OPO) coupled to a beam steering device 102, the OPO (e.g., operable, configured t, dimensioned, phase matched, and/or dispersion engineered) to generate electromagnetic radiation 108 comprising at least one of a signal or an idler in response to a pump, the beam steering device configured to provide emission 106, 108 away from the one or more chips 101 or photonic integrated circuits 107 in response to the at least one wavelength λₗ . . . λ_{N} of the electromagnetic radiation, e.g., selected so the steering angle 170 of the emission 106 or beam of the electromagnetic radiation 108 can span a range larger than 5 degrees with respect to a surface normal 172 of the beam steering device 102.

37. The device of clause 36, wherein the OPO is a wavelength-tunable OPO in which the wavelength of the signal and or idler can be tuned to provide beam steering of the electromagnetic radiation.

38. The device of clause 37, wherein tuning of the wavelength is achieved using an actuator 120 coupled to the OPO, the actuator comprising an electro-optic modulator (EOM), a thermo-optic modulator, a heater, a piezo-electric device, or a vernier tuning device in the form of coupled resonators further coupled to the OPO.

39. The device of any of the clauses 36-38, further comprising an input 112 for wavelength injection locking the OPO or wherein the OPO comprises a periodically poled nonlinear medium 114 tuned for a desired wavelength range comprising the wavelength.

40. The device of any of the clauses 36-39, further comprising an input coupler 156 to the OPO and a laser 110 operable for inputting input electromagnetic radiation comprising at least one of an input signal, an input idler, or the pump, wherein tuning the wavelength of the inputted light can tune the at least one wavelength of the signal or the idler generated by the OPO.

41. The device of any of the clauses 36-40, comprising a plurality of the OPOs coupled in a cascaded or parallel configuration to output the electromagnetic radiation in a chain of wavelength conversions that extends a wavelength tuning range of the electromagnetic radiation coupled to the beam steering device.

42. The device of any of the clauses 36-41, wherein the OPOs each comprise at least one of:
a nonlinear medium 114 comprising at least one of a different poling period or a configuration for outputting the electromagnetic radiation with a different center frequency,
or individual or multiplexed inputs/outputs 190.

43. The device of any of the clauses 1-42, wherein the at least one steering device 102 comprises at least one of a grating coupler, a nanophotonic antenna, an optical phased array, an arrayed delay line, or a metasurface.

44. The device of any of the clauses 1-43, wherein the OPO comprises a resonator 152 and one of the chips or photonic integrated circuits comprises the OPO and the beam steering device, and wherein the beam steering device 102 is placed inside or outside the resonator 152.

45. The device of any of the clauses 1-44, comprising a plurality of the beam steering devices configured for multibeam steering or steering of the electromagnetic radiation in different directions to enable two dimensional (2D) scanning of the beam or beams.

46. The device 400 of any of the clauses 1-44, wherein the OPO comprises a broadband OPO which has multimode operation for the signal and idler, for instance in the form of a frequency comb OPO or a short-pulse OPO, wherein the beam steering device 102 provides different steering angles for different spectral components of the electromagnetic radiation from the OPO, hence encoding the angular distribution to the spectral distribution of the electromagnetic radiation.

47. The device of any of the clauses 1-46, further comprising:
a receiving unit 450 on the same one of the chips 101 as the OPO or on a separate one of the chips to realize a ranging device wherein the receiving unit comprises one or more spectral filters 411 or a wavelength division demultiplexer WDM configured to route different wavelength components of a beam 420 comprising a received portion of the electromagnetic radiation 108, corresponding to different angles of incidence of the beam, to different outputs 452, or
an EO-based or PZT-based tunable filter, wherein the tunable filter can selectively route different angles of incidence of the beam 420 to one or multiple outputs.

48. A system or second device comprising, or the device of clause any of the clauses 1-47 further comprising, one or more of the OPOs and one or more of the beam steering devices configured for outputting a beam 106 of the electromagnetic radiation 108 with a desired scanning range 180 and speed.

49. The device of any of the clauses 1-48 further comprising a control circuit 306 controlling tuning of the at least one wavelength of the electromagnetic radiation to implement beam steering of the emission at sub-Hz to MHz speed over the scanning angle of the emission 106.

50. The device of clause 49, wherein the control circuit 306 is further configured to provide frequency-modulated continuous wave (FMCW) modulation of the electromagnetic radiation 108 as well as beam steering of the electromagnetic radiation.

51. The device of any of the clauses 1-50, optionally comprising a control circuit 306 further configured for controlling the OPO (e.g., configured or operable for, dispersion engineered, phase matched, and/or dimensioned for) outputting the electromagnetic radiation comprising pulses ranging from nanosecond to femtosecond pulse lengths useful for time of flight (TOF) measurements in addition to the beam steering of the beam.

52. The device of any of the clauses 1-50 comprising the OPOs (e.g., configured or operable for, dispersion engineered, phase matched, and/or dimensioned for) outputting the electromagnetic radiation comprising pulses ranging from nanosecond to femtosecond pulse lengths useful for time of flight (TOF) measurements in addition to the beam steering of the beam.

53. The device of any of the clauses 1-51, further comprising an input coupler 156 configured for inputting a continuous-wave or pulsed pump to the OPO.

54. The device of any of the clauses 1-53, wherein the OPO is configured to (e.g., dimensioned, quasi phase matched and/or dispersion engineered) output the electromagnetic radiation 108 comprising a frequency comb or a pulse having a duration in a range of 1 femtosecond (fs) to 1 nanosecond (ns).

55. The methods of clauses 21-24 using or making the devices of any of the clauses 1-54.

56. The device or method of any of the clauses, wherein the waveguide has a thickness of the order of a wavelength of the electromagnetic radiation and/or has a cross sectional area A that supports an electromagnetic mode which has more than 90% of its energy confined in the area A smaller than 5 microns by 5 microns, and/or wherein the top width W of the cross-section of the waveguide is less than 5 microns, and the height H of the cross-section of the waveguides (thin film thickness plus etch depth) is less than 1 micron (e.g., in a range of 50-500 nm, 600-800 nm, 600-990 nm).

57. The device of any of the clauses 1-56 wherein the steering angle is the range of the steering angle being more than 5 degrees differentiating with standard grating couplers for coupling to fiber where there is no steering intended and the grating is typically optimized for a narrower angular distribution.

59. A device comprising:
one or more chips or photonic integrated circuits comprising at least one optical parametric oscillator (OPO) coupled to a beam steering device, the OPO operable to generate electromagnetic radiation comprising at least one of a signal or an idler in response to a pump, the beam steering device configured to provide emission away from the chips or photonic integrated circuits in response to the at least one wavelength of the electromagnetic radiation selected so the steering angle 170 of the emission of the electromagnetic radiation can span a range larger than 5 degrees with respect to a surface normal 172 of the beam steering device.

60. A device comprising:
one or more chips or photonic integrated circuits comprising at least one optical parametric oscillator (OPO) coupled to a beam steering device, the OPO operable to generate electromagnetic radiation comprising at least one of a signal or an idler in response to a pump, the beam steering device configured to provide emission away from the chips or photonic integrated circuits in response to the at least one wavelength of the electromagnetic radiation selected so the emission of the electromagnetic radiation can be steered through a steering angle 175 or a range 175 larger than 5 degrees.

61. A device comprising:
one or more chips 101 or photonic integrated circuits comprising at least one optical parametric oscillator (OPO) coupled to a beam steering device 102, the OPO operable to generate electromagnetic radiation comprising at least one of a signal or an idler in response to a pump, the beam steering device configured to provide emission away from the chips or photonic integrated circuits in response to the at least one wavelength of the electromagnetic radiation selected so that the total steering angle 175 of the emission of the electromagnetic radiation can span a range larger than 5 degrees with respect to a surface normal 172 of the beam steering device.

62. The device of any of the clauses, wherein the scattering or diffracting property (e.g, grating periodicity and dimension) and/or wavelength tuning range of the OPO (e.g., at least 200 nm, at least 800 nm, at least 1 micron with respect to a center frequency (e.g., 1 micron, 2 micron, or in a range of 1-20 microns) is selected to achieve the desired steering angle 170, 175.

63. The device of any of the clauses, wherein the resonator comprises a ring resonator 154, the input coupler comprises an input waveguide 160 coupled to the resonator via a first gap and the output coupler 158 comprises an output waveguide 162 coupled to the resonator via a second gap.

### Further Device Embodiments

The present invention can further be embodied in many ways including, but not limited to, the following.

1. The use of an integrated wavelength-tunable optical parametric oscillator (OPO) including a nanophotonic output coupler, such as a grating coupler, to achieve beam steering.
(i) The OPO can be singly-, doubly-, or triply-resonant depending on the application.
(ii) Coarse and fine wavelength tuning can be achieved through at least one of electro-optic modulators, heaters, pump wavelength tuning, signal/idler wavelength injection locking, piezo-electric tuning, vernier tuning, and/or PPLN tuning.
(iii) Multiple OPOs can be cascaded to enable a chain of wavelength conversions, to further extend the wavelength tuning range.
(iv) Multiple copies of such OPOs can be included in one chip with different poling periods and different center frequencies, with individual or multiplexed inputs/outputs.
(v) Wavelength tuning can be performed on the same chip as the OPO or using an off-chip tunable pump laser or signal/idler wavelength laser.

2. Beam steering devices coupled to the OPO can include grating couplers, nanophotonic antennas, optical phased arrays, arrayed delayed lines, and metasurfaces.
(i) The steering device can be placed on-chip, inside or outside the OPO.
(ii) The steering device can be placed off-chip on a separate integrated photonic device.
(iii) Multiple beam steering devices can be included on one device to enable multi-beam steering or steering in different directions to enable 2D scanning.

3. The use of an ultra-broadband integrated OPO in conjunction with a beam steering device, in which the angular information is encoded in the spectral domain and vice versa.
(i) The detector will have spectral filters corresponding to different angles, or a EO-based or PZT-based tunable filter that can select different angles of incidence.

4. A ranging device consisting of multiple OPOs and/or multiple beam steering devices, to achieve desired scanning range and speed.

5. The proposed device can implement several different ranging mechanisms, such as
(i) Frequency-modulated continuous wave (FMCW) operation at kHz to MHz wavelength tuning speeds, when the OPO is acting as a tunable source.
(ii) Time of flight (TOF) operation, when the OPO is operating in the picosecond or nanosecond regimes.

6. The proposed device can be pumped by continuous-wave or pulsed sources, via edge coupling or surface coupling.

### Further Device Examples

1. A device comprising:
one or more chips or photonic integrated circuits comprising at least one optical parametric oscillator (OPO) in which the electromagnetic radiation from the OPO, which includes one or both of the signal and idler are coupled to at least one beam steering device, wherein the beam steering device provides emission away from the chips or photonic integrated circuits in response to the wavelength of the electromagnetic radiation wherein the steering angle of the electromagnetic radiation depends on its wavelength and the steering angle is larger than 5 degrees.

2. The device of clause 1, wherein the OPO is a wavelength-tunable OPO in which the signal and or idler wavelength of the OPO can be tuned to provide beam steering.

3. The device of clause 2, wherein the wavelength tuning is achieved using an actuator coupled to the OPO which comprises an electro-optic modulator, a thermo-optic modulator, a heater, a piezo-electric device, or a vernier tuning device in the form of coupled resonators further coupled to the OPO.

4. The device of clause 1, further comprising an input for wavelength injection locking the OPO or wherein the OPO comprises a periodically poled nonlinear medium tuned for a desired wavelength range of the electromagnetic radiation.

5. The device of clause 1, further comprising an input coupler to the OPO and a laser operable for inputting at least one of a signal, idler, or pump that tuning the wavelength of the inputted light can tune the OPO signal or idler wavelengths.

6. The device of clause 1, comprising a plurality of the OPOs coupled in a cascaded or parallel configuration to output the electromagnetic radiation in a chain of wavelength conversions that extends a wavelength tuning range of the electromagnetic radiation coupled to the output coupler.

7. The device of clause 6, wherein the OPOs each comprise at least one of:
a nonlinear medium comprising at least one of a different poling period or a configuration for outputting the electromagnetic radiation with a different center frequency,
or individual or multiplexed inputs/outputs.

8. The device of clause 1, wherein the at least one steering device comprises at least one of a grating coupler, nanophotonic antenna, an optical phased array, an arrayed delay lines, or a metasurface.

9. The device of clause 1, comprising one of the chips or photonic integrated circuits comprising the OPO and the output coupler and wherein the output coupler is placed inside or outside the OPO resonator.

10. The device of clause 1, comprising a plurality of the steering devices configured for multibeam steering or steering of the electromagnetic radiation in different directions to enable 2D scanning of the beam or beams.

11. The device of clause 1, wherein the OPO comprises a broadband OPO which has multimode operation for the signal and idler, for instance in the form of a frequency comb OPO or a short-pulse OPO, wherein the beam steering device provides different steering angle for different spectral component of the electromagnetic radiation from the OPO hence encoding the angular distribution to the spectral distribution of the electromagnetic radiation.

12. The device of clause 1, further comprising:
a receiving unit on the same chip or separately to realize a ranging device wherein the receiving unit comprises one or more spectral filters or a wavelength division demultiplexer configured to route different wavelength components of the received electromagnetic radiation, corresponding to different angles of incidence of the beam, to different outputs, or
an EO-based or PZT-based tunable filter, wherein the tunable filter can selectively route different angles of incidence to one or multiple outputs.

13. A device comprising the device of clause 1 comprising one or more of the OPOs and one or more of the output couplers configured for outputting the beam with a desired scanning range 180 and speed.

14. The device of clause 1 further comprising a control circuit controlling tuning of wavelengths of the electromagnetic radiation to implement the beam steering at sub-Hz to MHz speed over the scanning angle.

15. The device of clause 14, wherein the control circuit is further configured to provide frequency-modulated continuous wave (FMCW) electromagnetic radiation as well as the beam steering.

16. The device of clause 14, wherein the control circuit is further configured for outputting the electromagnetic radiation comprising pulses ranging from nanosecond to femtosecond pulse lengths useful for time of flight (TOF) measurements in addition to the beam steering.

17. The device of clause 1, further comprising an input coupler configured for inputting a continuous-wave or pulsed pump to the OPO.

18. The device of clause 1, wherein the OPO is configured to output the electromagnetic radiation comprising a frequency comb or a pulse having a duration in a range of 1 fs to 1 ns.

19. A transceiver comprising the device of clause 1, further comprising:
an input coupler for receiving the beam after interaction of the beam with a target; and
a detector for detecting the electromagnetic radiation received at the input coupler.

20. A LIDAR or remote sensing system comprising the device of any of the clauses.

### Advantages and Improvements

Optical parametric oscillators (OPOs) are devices based on parametric amplification within an optical resonator, and can generate coherent, tunable light sources, as well as broadband frequency combs. For this reason, OPOs have already been widely used as a comb source for high precision laser spectroscopy as well as airborne LiDAR [8-9]. Recently, advancements in integrated photonics technologies have enabled reductions of OPO footprints down to chip-scale, on platforms such as silicon nitride and lithium niobate, which opened more possibilities for device miniaturization [10-13]. On the other side, various on-chip active and passive beam steering devices have been demonstrated on various platforms for LiDAR applications. For example, gratings commonly appear in metasurfaces structures for beam steering due to the frequency dependency of outcoupling angle based on the Bragg condition, as well as high coupling efficiency and easy fabrication process.

The present invention uses tunable or broadband integrated OPO with active or passive beam steering devices for high-speed ranging on a compact, low-cost platform. Examples of beam steering devices include grating couplers, optical phased arrays, arrayed waveguide delay lines, nanophotonic antennas, metasurfaces, etc. The beam steering device can be inside or outside of the OPO structure. Under broadband operation, the angular information is encoded in the spectral domain and vice versa, and the detector may have multiple spectral filters corresponding to different angles or a single tunable filter. The tunable filter can be electro-optic (EO) based or piezoelectric (PZT)-based. This invention can be realized across multiple material platforms with application specific parameters to optimize performance, such as bandwidth, tuning range, tuning speed, spatial/temporal resolution, polarization, field of view (FOV), etc. The scanning can be done in 1D and 2D. Multiple OPOs can be fabricated on the same chip along with multiple beam steering devices, to extend the wavelength tuning range and subsequent FOV in 1D and 2D scanning.

The combination of a tunable OPO and a grating coupler would enable free-space beam steering, for example by using a high-speed electro-optical modulator or heater, as depicted in FIG. 1. Alternatively, instead of tunable OPOs, we can use ultra-broadband integrated OPOs in conjunction with similar beam steering devices. Under pulsed (synchronously-pumped) operation, instead of controlling angle through wavelength tuning, the angular information is encoded in the spectral domain and vice versa, as depicted in FIG. 3. On the detection side, multiple spectral filters or a single tunable filter can be used to select different angles of incidence. Additionally, with the availability of diode pumped tunable OPOs, the requirement of a high-power pump laser is no longer a set-back for compact LiDAR systems, further simplifying the system footprint and cost.

### REFERENCES

The following references are incorporated by reference herein
[1] Kim, I., Martins, R. J., Jang, J., Badloe, T., Khadir, S., Jung, H.-Y., Kim, H., Kim, J., Genevet, P., & Rho, J. (2021). Nanophotonics for light detection and ranging technology. Nature Nanotechnology, 16(5), 508-524. https://doi.org/10.1038/s41565-021-00895-3
[2] Na, Y., Jeon, C.-G., Ahn, C., Hyun, M., Kwon, D., Shin, J., & Kim, J. (2020). Ultrafast, sub-nanometre-precision and multifunctional time-of-flight detection. Nature Photonics, 14(6), 355-360. https://doi.org/10.1038/s41566-020-0586-0
[3] Yang, D., Liu, Y., Chen, Q., Chen, M., Zhan, S., Cheung, N., Chan, H.-Y., Wang, Z., & Li, W. J. (2023). Development of the high angular resolution 360° lidar based on scanning MEMS Mirror. Scientific Reports, 13(1). https://doi.org/10.1038/s41598-022-26394-6
[4] Wang, D., Watkins, C., & Xie, H. (2020). MEMS MIRRORS FOR LIDAR: A Review. Micromachines, 11(5), 456. https://doi.org/10.3390/mi11050456
[5] Bhandari, B., Wang, C., Gwon, J.-Y., Heo, J.-M., Ko, S.-Y., Oh, M.-C., & Lee, S.-S. (2022). Dispersive silicon-nitride optical phased array incorporating arrayed waveguide delay lines for passive line beam scanning. Scientific Reports, 12(1). https://doi.org/10.1038/s41598-022-23456-7
[6] Huang, Y.-W., Lee, H. W. H., Sokhoyan, R., Pala, R. A., Thyagarajan, K., Han, S., Tsai, D. P., & Atwater, H. A. (2016). Gate-tunable conducting oxide metasurfaces. Nano Letters, 16(9), 5319-5325. https://doi.org/10.1021/acs.nanolett.6b00555.s001
[7] Xie, Y.-Y., Ni, P.-N., Wang, Q.-H., Kan, Q., Briere, G., Chen, P.-P., Zhao, Z.-Z., Delga, A.,
[8] Ren, H.-R., Chen, H.-D., Xu, C., & Genevet, P. (2020). Metasurface-integrated vertical cavity surface-emitting lasers for programmable directional lasing emissions. Nature Nanotechnology, 15(2), 125-130. https://doi.org/10.1038/s41565-019-0611-y
[9] Muraviev, A. V., Smolski, V. O., Loparo, Z. E., & Vodopyanov, K. L. (2018). Massively Parallel Sensing of trace molecules and their isotopologues with broadband subharmonic mid-infrared frequency combs. Nature Photonics, 12(4), 209-214. https://doi.org/10.1038/s41566-018-0135-2
[10] Ma, J., Lu, T., He, Y., Jiang, Z., Hou, C., Li, K., Liu, F., Zhu, X., & Chen, W. (2020). Compact dual-wavelength blue-green laser for Airborne Ocean Detection Lidar. Applied Optics, 59(10). https://doi.org/10.1364/ao.382174
[11] Perez, E. F., Moille, G., Lu, X., Stone, J., Zhou, F., & Srinivasan, K. (2023). High-performance Kerr Microresonator optical parametric oscillator on a silicon chip. Nature Communications, 14(1). https://doi.org/10.1038/s41467-022-35746-9
[12] Ledezma, L., Roy, A., Costa, L., Sekine, R., Gray, R., Guo, Q., Nehra, R., Briggs, R. M., & Marandi, A. (2023). Octave-spanning tunable infrared parametric oscillators in nanophotonics. Science Advances, 9(30). https://doi.org/10.1126/sciadv.adf9711
[13] Sekine, R., Gray, R. M., Ledezma, L., Zhou, S., Guo, Q., & Marandi, A. (2023, September 8). Multi-octave frequency comb from an ultra-low-threshold nanophotonic parametric oscillator. arXiv.org. https://arxiv.org/abs/2309.04545.
[14] Roy, A., Ledezma, L., Costa, L., Gray, R., Sekine, R., Guo, Q., Liu, M., Briggs, R. M., & Marandi, A. (2023). Visible-to-mid-IR tunable frequency comb in nanophotonics. Nature Communications, 14(1). https://doi.org/10.1038/s41467-023-42289-0
[15] Sun, J., Timurdogan, E., Yaacobi, A., Hosseini, E. S., & Watts, M. R. (2013). Large-scale nanophotonic phased array. Nature, 493(7431), 195-199. https://doi.org/10.1038/naturel 1727
[16] Wu, D., Guo, W., & Yi, Y. (2019). Compound period grating coupler for double beam generation and steering. Applied Optics, 58(2), 361. https://doi.org/10.1364/ao.58.000361
[17] Doylend, J. K., Heck, M. J., Bovington, J. T., Peters, J. D., Coldren, L. A., & Bowers, J. E. (2011). Two-dimensional free-space beam steering with an optical phased array on silicon-on-insulator. Optics Erpress, 19(22), 21595. https://doi.org/10.1364/oe.19.021595
[18] Diddams S A, Hollberg L, Mbele V. Molecular fingerprinting with the resolved modes of a femtosecond laser frequency comb. Nature. 2007 Feb. 8; 445(7128):627-30.
[19] U.S. patent application Ser. No. 18/805,408 filed Aug. 14, 2024, entitled “ON-CHIP ULTRA SHORT PULSE SYNTHESIZER” and U.S. patent application Ser. No. 18/662,730, filed May 13, 2024, by Alireza Marandi, Luis. M. Ledezma, Arkadev Roy, Ryoto Sekine, and Robert M. Gray, entitled “THIN FILM SYNCHRONOUSLY PUMPED OPTICAL PARAMETRIC OSCILLATORS.
[20] US Patent Publication No. 20220123516 entitled a1CHIP-INTEGRATED MODE-LOCKED LASERS BASED ON THIN-FILM NONLINEAR WAVEGUIDES.
[21] US Patent Publication No. 2024-0348015 A1 entitled SURFACE-COUPLED INTEGRATED-CAVITY SEMICONDUCTOR LASER
[22] U.S. patent application Ser. No. 18/805,408 filed Aug. 14, 2024 entitled ON-CHIP PHOTONIC ULTRA-SHORT-PULSE SYNTHESIZER

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device comprising:
one or more chips or photonic integrated circuits comprising at least one optical parametric oscillator (OPO) coupled to a beam steering device, the OPO operable to generate electromagnetic radiation comprising at least one of a signal or an idler in response to a pump, the beam steering device configured to provide emission away from the chips or photonic integrated circuits in response to the at least one wavelength of the electromagnetic radiation selected so the steering angle of the emission of the electromagnetic radiation can span a range larger than 5 degrees with respect to a surface normal of the beam steering device.

2. The device of claim 1, wherein the OPO is a wavelength-tunable OPO in which the wavelength of the signal and or idler can be tuned to provide beam steering of the electromagnetic radiation.

3. The device of claim 2, wherein tuning of the wavelength is achieved using an actuator coupled to the OPO, the actuator comprising an electro-optic modulator, a thermo-optic modulator, a heater, a piezo-electric device, or a vernier tuning device in the form of coupled resonators further coupled to the OPO.

4. The device of claim 1, further comprising an input for wavelength injection locking the OPO or wherein the OPO comprises a periodically poled nonlinear medium tuned for a desired wavelength range comprising the wavelength.

5. The device of claim 1, further comprising an input coupler to the OPO and a laser operable for inputting input electromagnetic radiation comprising at least one of an input signal, an input idler, or the pump, wherein tuning the wavelength of the inputted light can tune theat least one wavelength of the signal or the idler generated by the OPO.

6. The device of claim 1, comprising a plurality of the OPOs coupled in a cascaded or parallel configuration to output the electromagnetic radiation in a chain of wavelength conversions that extends a wavelength tuning range of the electromagnetic radiation coupled to the beam steering device.

7. The device of claim 6, wherein the OPOs each comprise at least one of:
a nonlinear medium comprising at least one of a different poling period or a configuration for outputting the electromagnetic radiation with a different center frequency,
or individual or multiplexed inputs/outputs.

8. The device of claim 1, wherein the at least one steering device comprises at least one of a grating coupler, a nanophotonic antenna, an optical phased array, an arrayed delay line, or a metasurface.

9. The device of claim 1, wherein the OPO comprises a resonator and one of the chips or photonic integrated circuits comprises the OPO and the beam steering device, and wherein the beam steering device is placed inside or outside the resonator.

10. The device of claim 1, comprising a plurality of the beam steering devices configured for multibeam steering or steering of the electromagnetic radiation in different directions to enable two dimensional (2D) scanning of the beam or beams.

11. The device of claim 1, wherein the OPO comprises a broadband OPO which has multimode operation for the signal and idler, for instance in the form of a frequency comb OPO or a short-pulse OPO, wherein the beam steering device provides different steering angles for different spectral components of the electromagnetic radiation from the OPO, hence encoding the angular distribution to the spectral distribution of the electromagnetic radiation.

12. The device of claim 1, further comprising:
a receiving unit on the same one of the chips as the OPO or on a separate one of the chips to realize a ranging device wherein the receiving unit comprises one or more spectral filters or a wavelength division demultiplexer configured to route different wavelength components of a beam comprising a received portion of the electromagnetic radiation, corresponding to different angles of incidence of the beam, to different outputs, or
an EO-based or PZT-based tunable filter, wherein the tunable filter can selectively route different angles of incidence of the beam to one or multiple outputs.

13. A device comprising the device of claim 1 comprising one or more of the OPOs and one or more of the beam steering devices configured for outputting a beam of the electromagnetic radiation with a desired scanning range and speed.

14. The device of claim 1 further comprising a control circuit controlling tuning of the at least one wavelength of the electromagnetic radiation to implement beam steering of the emission at sub-Hz to MHz speed over the scanning angle of the emission.

15. The device of claim 14, wherein the control circuit is further configured to provide frequency-modulated continuous wave (FMCW) modulation of the electromagnetic radiation as well as beam steering of the electromagnetic radiation.

16. The device of claim 14, wherein the control circuit is further configured for outputting the electromagnetic radiation comprising pulses ranging from nanosecond to femtosecond pulse lengths useful for time of flight (TOF) measurements in addition to the beam steering of the beam.

17. The device of claim 1, further comprising an input coupler configured for inputting a continuous-wave or pulsed pump to the OPO.

18. The device of claim 1, wherein the OPO is configured to output the electromagnetic radiation comprising a frequency comb or a pulse having a duration in a range of 1 fs to 1 ns.

19. A transceiver comprising the device of claim 1, further comprising:
an input coupler for receiving the beam after interaction of the emission with a target; and
a detector for detecting the electromagnetic radiation received at the input coupler.

20. A LIDAR or remote sensing system comprising the device of claim 1.
